(19) United States
(12) Patent Application Publication
(10) Pub. No.: US 2026/0254890 A1
(43) Pub. Date: Aug. 27, 2026

(54) ELECTRONIC DEVICE

(71) Applicant: Samsung Display Co., Ltd., Yongin-si (KR)

(72) Inventor: Sang Wol LEE, Yongin-si (KR)

(21) Appl. No.: 19/313,062

(22) Filed: Aug. 28, 2025

(30) Foreign Application Priority Data
Feb. 26, 2025 (KR) 10-2025-0024907

(51) Int. Cl. H04M 1/02; G06F 1/16

(52) U.S. Cl. CPC H04M 1/0216; G06F 1/1618; G06F 1/1652; H04M 1/0268

(57) ABSTRACT

An electronic device includes a display device, a first plate and a second plate under the display device, a hinge between the first plate and the second plate, a hinge cover covering the hinge below the hinge, a first wing plate connected with the hinge and the first plate, and a second wing plate connected with the hinge and the second plate. In a first folding period in which the first plate and the second plate rotate at a first angle: a first curved surface of the hinge cover coincides with a rotation trajectory of a curved portion of the first wing plate in a cross-sectional view; and a second curved surface of the hinge cover coincides with a rotation trajectory of a curved portion of the second wing plate in the cross-sectional view.

### CROSS-REFERENCE TO RELATED APPLICATION

The present application claims priority to and the benefit of Korean Patent Application No. 10-2025-0024907, filed on Feb. 26, 2025, in the Korean Intellectual Property Office, the entire disclosure of which is incorporated herein by reference.

### BACKGROUND

### 1. Field

The present disclosure relates to an electronic device.

### 2. Description of the Related Art

Recently, as interest in information display has increased, research and development on a display device and an electronic device including the same have been conducted.

### SUMMARY

One or more embodiments of the present disclosure are to provide an electronic device capable of minimizing or reducing image distortion and minimizing or reducing thickness during folding of the electronic device.

Embodiments are not limited to the above-mentioned embodiment, and other embodiments that are not mentioned may be clearly understood by a person skilled in the art from the following description.

One or more embodiments of the present disclosure are directed to an electronic device that includes: a display device, a first plate and a second plate under the display device, a hinge between the first plate and the second plate, a hinge cover covering the hinge below the hinge, a first wing plate connected with the hinge and the first plate, and a second wing plate connected with the hinge and the second plate. In a first folding period in which the first plate and the second plate are configured to rotate at a first angle: a first curved surface of the hinge cover coincides with a first rotation trajectory of a first curved portion of the first wing plate in a cross-sectional view; and a second curved surface of the hinge cover coincides with a second rotation trajectory of a second curved portion of the second wing plate in the cross-sectional view.

The first curved surface of the hinge cover may be in contact with the first curved portion of the first wing plate in the first folding period.

The first wing plate and the first plate may be parallel in the first folding period.

The first angle may be greater than or equal to 90 degrees and less than or equal to 180 degrees.

In a second folding period in which the first plate and the second plate are configured to rotate at a second angle, the first curved portion of the first wing plate may be spaced apart from the first curved surface of the hinge cover.

The hinge may include a first roller on a first side of the hinge cover and a second roller on a second side of the hinge cover.

The first roller may be in contact with the first wing plate in the second folding period.

The first wing plate may include a groove portion in contact with the first roller in the second folding period, and a thickness of the groove portion may be smaller than a thickness of the curved portion.

The first wing plate and the first plate may be non-parallel in the second folding period.

An angle formed between the first wing plate and the first plate in the second folding period may be greater than an angle formed between the first wing plate and the first plate in the first folding period.

The second angle may be less than 90 degrees.

The electronic device may further include a first lever rotating with respect to a first rotation axis and a second lever rotating with respect to a second rotation axis, the first wing plate may rotate along the first lever, and the second wing plate may rotate along the second lever.

One or more embodiments of the present disclosure are also directed to an electronic device that includes a display device, a first plate and a second plate under the display device, a hinge disposed between the first plate and the second plate and including a first roller and a second roller spaced apart from each other, a hinge cover below the hinge and covering the hinge, a first wing plate connected with the hinge and the first plate, and a second wing plate connected with the hinge and the second plate. In a first folding period in which the first plate and the second plate are configured to rotate at a first angle, a first area of the first wing plate is in contact with a first curved surface of the hinge cover, and a second area of the second wing plate is in contact with a second curved surface of the hinge cover. In a second folding period in which the first plate and the second plate are configured to rotate at a second angle, the first area of the first wing plate is in contact with the first roller, and the second area of the second wing plate is in contact with the second roller.

The first area of the first wing plate may be spaced apart from the first curved surface of the hinge cover in the second folding period.

An angle formed between the first wing plate and the first plate in the second folding period may be greater than an angle formed between the first wing plate and the first plate in the first folding period.

The first wing plate and the first plate may be parallel in the first folding period.

In the second folding period, an angle between the first plate and the second plate may be greater than an angle between the first wing plate and the second wing plate.

The first angle may be greater than or equal to 90 degrees and less than or equal to 180 degrees.

The second angle may be less than 90 degrees.

A thickness of the first area of the first wing plate may be greater than a thickness of the second area of the first wing plate.

Specific details of other embodiments are included in the detailed description and drawings.

According to one or more embodiments, in the first folding period, image distortion may be minimized or reduced by preventing or reducing tilting of the wing plates. In some embodiments, in the second folding period, the wing plates are tilted so that the plates are folded parallel to each other, to reduce the thickness of the electronic device.

Effects according to embodiments are not limited by what is illustrated above, and more diverse effects are included in the present specification.

### BRIEF DESCRIPTION OF THE DRAWINGS

FIG. 1 is a perspective view of an electronic device according to an embodiment.

FIG. 2 is a perspective view of the electronic device of FIG. 1 in a semi-folded state according to an embodiment.

FIG. 3 is a perspective view of the electronic device of FIG. 1 in a folded state according to an embodiment.

FIG. 4 is a perspective view of an electronic device including a folding set according to an embodiment.

FIG. 5 is an exploded perspective view of the electronic device of FIG. 4.

FIG. 6 is a perspective view of a folding set according to an embodiment.

FIG. 7 is a perspective view of the folding set of FIG. 6 in a semi-folded state according to an embodiment.

FIG. 8 is a perspective view of the folding set of FIG. 6 in a folded state according to one embodiment.

FIG. 9 is a cross-sectional view of the folding set of FIG. 6 taken along line A-A′.

FIG. 10 is a cross-sectional view of the folding set of FIG. 9 in a semi-folded state according to one embodiment.

FIG. 11 is a cross-sectional view of the folding set of FIG. 9 in a folded state according to one embodiment.

FIG. 12 is an enlarged cross-sectional view of wing plates and a hinge cover of the folding set of FIG. 9.

FIG. 13 is an enlarged cross-sectional view of the wing plates and the hinge cover of the folding set of FIG. 12 in a semi-folded state according to one embodiment.

FIG. 14 is an enlarged cross-sectional view of the wing plates and the hinge cover of the folding set of FIG. 12 in a folded state according to one embodiment.

FIG. 15 is an exemplary diagram illustrating wing plates and a hinge cover according to an embodiment.

FIG. 16 is a block diagram of a display device according to an embodiment.

FIG. 17 is a block diagram illustrating an embodiment of any one of sub-pixels of the display device of FIG. 16.

FIG. 18 is a plan view of a display panel of the display device of FIG. 16 according to one embodiment.

FIG. 19 is a block diagram of an electronic device according to an embodiment.

FIG. 20 is a schematic diagram of an electronic device according to various embodiments.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

Throughout the specification, when a part is “connected” to another part, this may include not only a case where the part is “directly connected” but also a case where it is “indirectly connected” with another element interposed therebetween. The terminology used herein is for the purpose of describing particular embodiments and is not intended to limit the disclosure. Throughout the specification, when it is said that a part may “include” a component, this may mean that other components may be further included, rather than excluding other components, unless otherwise specified. “At least one of X, Y, and Z”, “at least one of X, Y, or Z,” and “at least one selected from the group consisting of X, Y and Z” can be interpreted as one X, one Y, one Z, or any combination of two or more of X, Y or Z (e.g., XYZ, XY, YZ, XZ). Here, “and/or” may include any combination of one or more of the corresponding configurations.

Here, terms such as first, second, and the like may be used to describe various components, but these components are not limited to these terms. These terms may be used to distinguish one component from another. Accordingly, a first component may refer to a second component without departing from what is disclosed herein.

Spatially relative terms such as “below”, “above”, “under,” “on,” and the like may be used for purposes of description, thereby describing a relationship of one element or feature to another element(s) or feature(s), as shown in the figures. Spatially relative terms are intended to include different directions in use, operation, and/or manufacture, in addition to the directions depicted in the figures. For example, if the device shown in the figure is flipped over, elements depicted as being “below” or “under” other elements or features may be positioned in a direction “above” or “on” the other elements or features. Thus, in an embodiment, the term “below” or “under” may include both directions above and below, or both directions on and under. In addition, the device may be directed in another direction (e.g., rotated 90 degrees or in another direction), and thus, the spatially relative terms used herein may be interpreted accordingly.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

Various embodiments may be described with reference to the figures schematizing ideal embodiments. Accordingly, it will be appreciated that the shapes may vary depending on, for example, tolerances and/or manufacturing techniques. Accordingly, the embodiments disclosed herein may not be construed as limited to the particular shapes shown, but may be construed as including, for example, changes in shapes that occur as a result of fabrication. As such, the shapes shown in the drawings may not show actual shapes of regions of the apparatus, and the present embodiments are not limited thereto.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

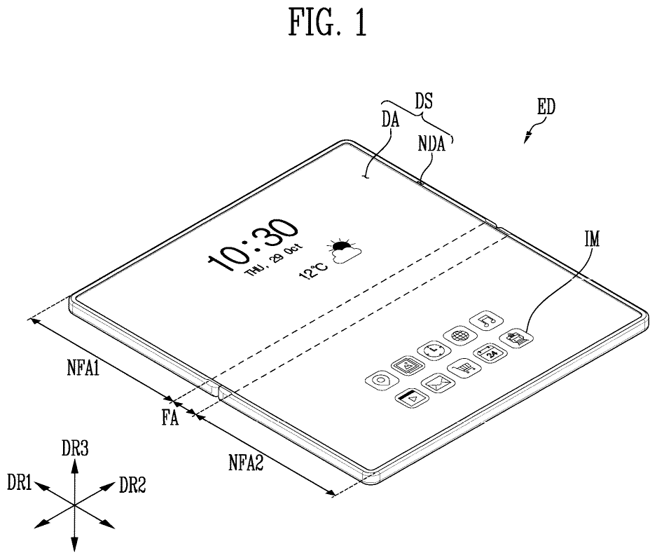

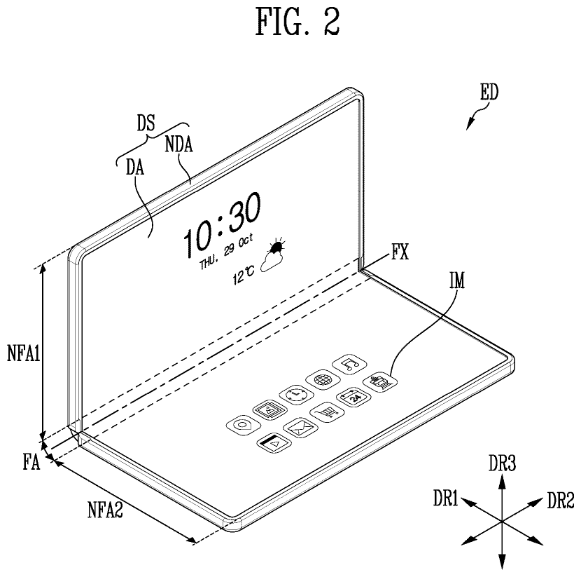

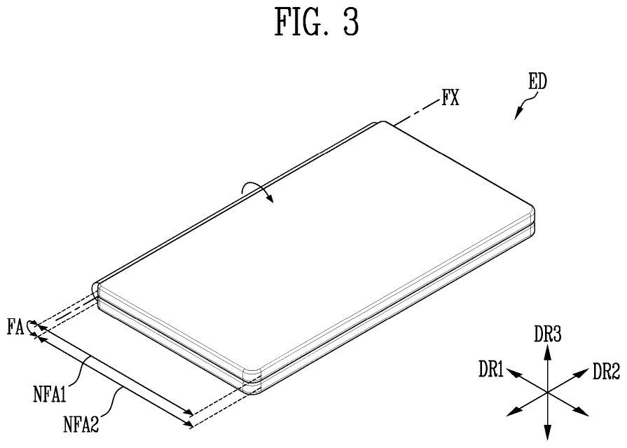

FIG. 1 is a perspective view of an electronic device according to an embodiment. FIG. 2 is a perspective view of the electronic device of FIG. 1 in a semi-folded state according to an embodiment. FIG. 3 is a perspective view of the electronic device of FIG. 1 in a folded state according to an embodiment.

The electronic device ED shown in FIG. 1 may be a tablet PC or a laptop, and may be a foldable electronic device.

Referring to FIG. 1, an electronic device ED according to an embodiment may have long sides extending parallel to a first direction DR1 and short sides extending parallel to a second direction DR2 intersecting the first direction DR1. Corners of the electronic device ED connecting the long sides and the short sides of the electronic device ED may have a curved shape. Corners of the electronic device ED having a curved shape may be defined as round corners.

Hereinafter, a direction substantially perpendicularly intersecting a plane defined by the first direction DR1 and the second direction DR2 is defined as a third direction DR3. “In a plan view” may be defined herein as a state viewed in the third direction DR3.

The electronic device ED may include a folding area FA and non-folding areas NFA1 and NFA2. The non-folding areas NFA1 and NFA2 may include a first non-folding area NFA1 and a second non-folding area NFA2. The folding area FA may be located between the first non-folding area NFA1 and the second non-folding area NFA2. The first non-folding area NFA1, the folding area FA, and the second non-folding area NFA2 may be arranged along the first direction DR1.

Exemplarily, one folding area FA and two non-folding areas NFA1 and NFA2 are shown, but the number of folding area FA and non-folding area NFA1 and NFA2 is not limited thereto. For example, the electronic device ED may include three or more non-folding areas and two or more folding area located between the non-folding areas.

An upper surface (or a top surface) of the electronic device ED may be defined as a display surface DS and may have a plane defined by the first direction DR1 and the second direction DR2. Images IM generated by the electronic device ED may be provided to the user through the display surface DS.

The display surface DS may include a display area DA and a non-display area NDA around the display area DA. The display area DA may display an image, and the non-display area NDA may not display an image. The non-display area NDA may surround the display area DA. Although not shown, the electronic device ED may further include at least one sensor and at least one camera.

Referring to FIGS. 2 and 3, the electronic device ED may be a foldable display device. For example, the folding area FA may be folded relative to a folding axis FX parallel to the second direction DR2 to fold the electronic device ED.

In an embodiment where the electronic device ED is folded, the first non-folding area NFA1 and the second non-folding area NFA2 may face each other. The electronic device ED may be in-folded so that the display surface DS is not exposed to the outside. However, embodiments are not limited thereto. For example, the electronic device ED may be out-folded such that the display surface DS may be exposed to the outside with respect to the folding axis FX.

Referring to FIG. 1, in an embodiment where the electronic device ED is in an unfolded state, the first non-folding area NFA1 and the second non-folding area NFA2 may be horizontally arranged in the first direction DR1. In this embodiment, an angle between the first non-folding area NFA1 and the second non-folding area NFA2 may be 180 degrees.

Referring to FIG. 2, the electronic device ED may be folded such that an angle between the first non-folding area NFA1 and the second non-folding area NFA2 may be 90 degrees. For example, in an embodiment where the electronic device ED is implemented as a laptop, a user may use the electronic device ED with folding area FA at a desired angle (e.g., about 70 degrees to 120 degrees). While the user uses the electronic device ED, an image may be displayed in the first non-folding area NFA1, the folding area FA, and the second non-folding area NFA2. Although not shown, in an embodiment where the electronic device ED is a laptop, the electronic device ED may further include a keyboard that is an input device, but is not necessarily limited thereto.

Referring to FIG. 3, the electronic device ED may be folded such that an angle between the first non-folding area NFA1 and the second non-folding area NFA2 may be 0 degrees. The user may carry the electronic device ED by folding the folding area FA at a desired angle (e.g., about 0 degrees). For example, the first non-folding area NFA1 and/or the second non-folding area NFA2 may rotate so that the display surface DS of the first non-folding area NFA1 faces the display surface DS of the second non-folding area NFA2.

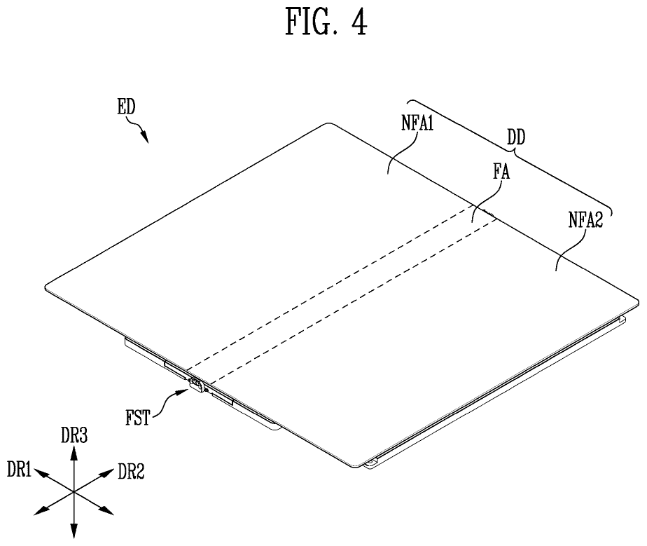

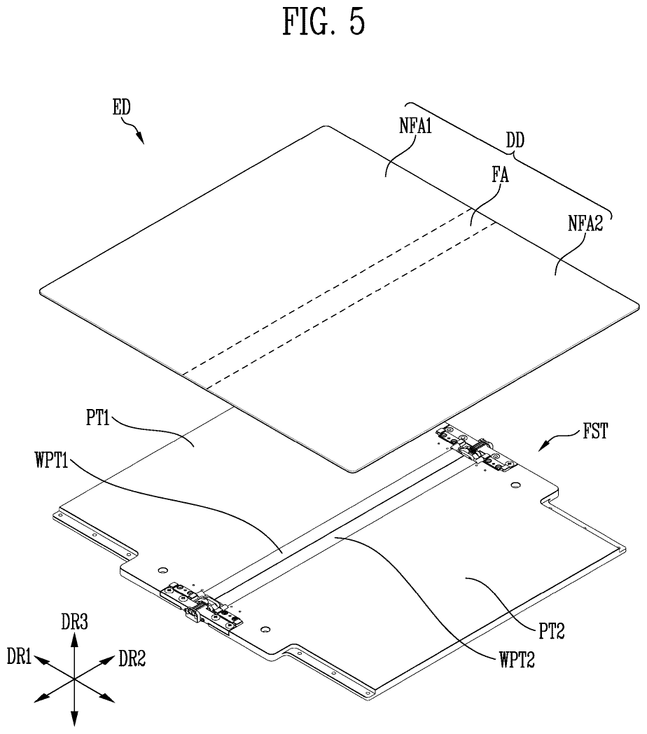

FIG. 4 is a perspective view of an electronic device including a folding set according to an embodiment. FIG. 5 is an exploded perspective view of the electronic device of FIG. 4.

In some embodiments, such as the embodiment depicted in FIG. 5, the electronic device ED is separated into a folding set FST and a display device DD.

Referring to FIGS. 4 and 5, the electronic device ED may include a display device DD and/or a folding set FST disposed under the display device DD.

The folding set FST may support the display device DD. The display device DD may be attached to the folding set FST by an adhesive, but is not necessarily limited thereto. The folding set FST may be a folding mechanism for folding the display device DD.

The folding set FST may be folded around a folding axis, which is parallel to the second direction DR2 and overlapping the folding area FA in a plan view, to fold the display device DD.

The folding set FST may include a first plate PT1, a second plate PT2, a first wing plate WPT1, and/or a second wing plate WPT2.

The first plate PT1 and the second plate PT2 may include a plane defined by the first and second directions DR1 and DR2. The first plate PT1 and the second plate PT2 may extend longer in the second direction DR2 than in the first direction DR1.

The first plate PT1 and the second plate PT2 may be arranged along the first direction DR1. The first plate PT1 may be disposed or located below the first non-folding area NFA1 of the display device DD, and may overlap the first non-folding area NFA1 in a plan view. The second plate PT2 may be disposed or located below the second non-folding area NFA2 of the display device DD, and may overlap the second non-folding area NFA2 in a plan view.

The first wing plate WPT1 and the second wing plate WPT2 may include a plane defined by the first and second directions DR1 and DR2. The first wing plate WPT1 and the second wing plate WPT2 may extend longer in the second direction DR2 than in the first direction DR1.

The first wing plate WPT1 and the second wing plate WPT2 may be arranged along the first direction DR1. The first wing plate WPT1 and the second wing plate WPT2 may be disposed or located below the folding area FA and may overlap the folding area FA in a plan view.

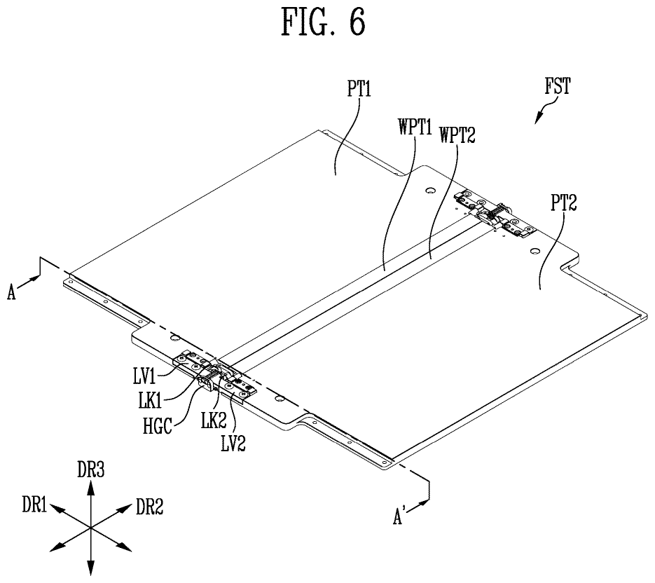

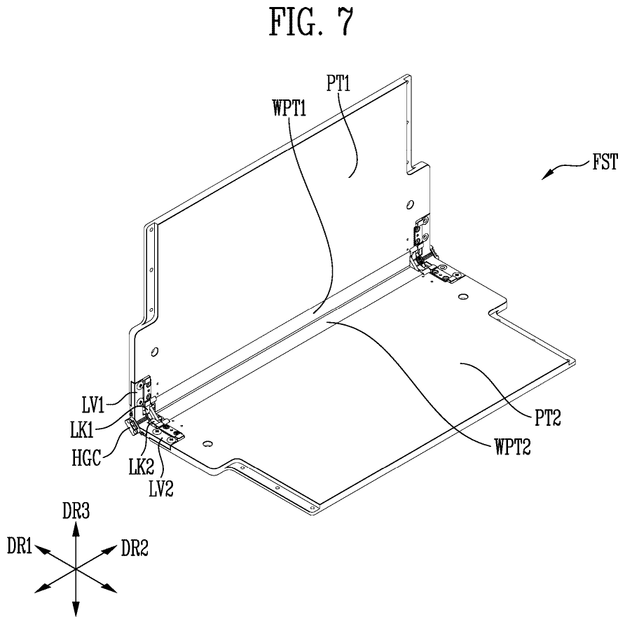

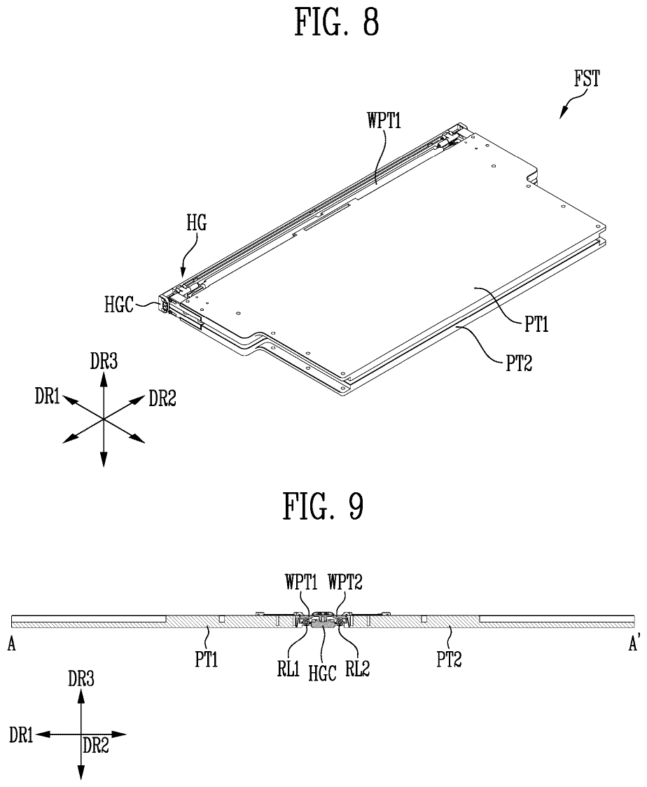

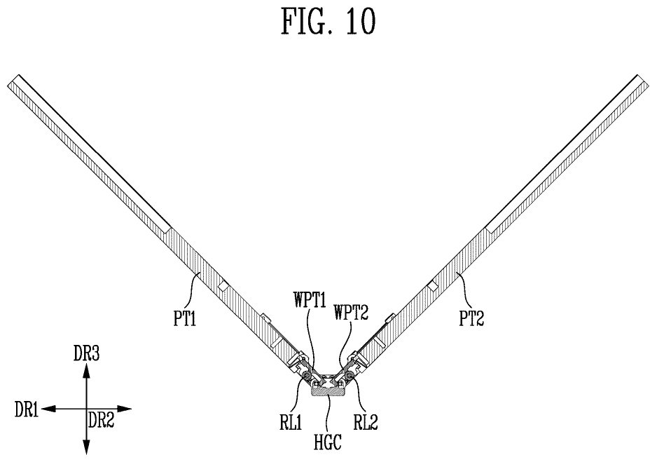

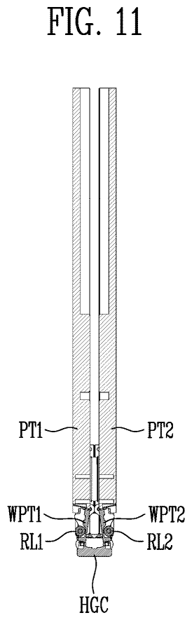

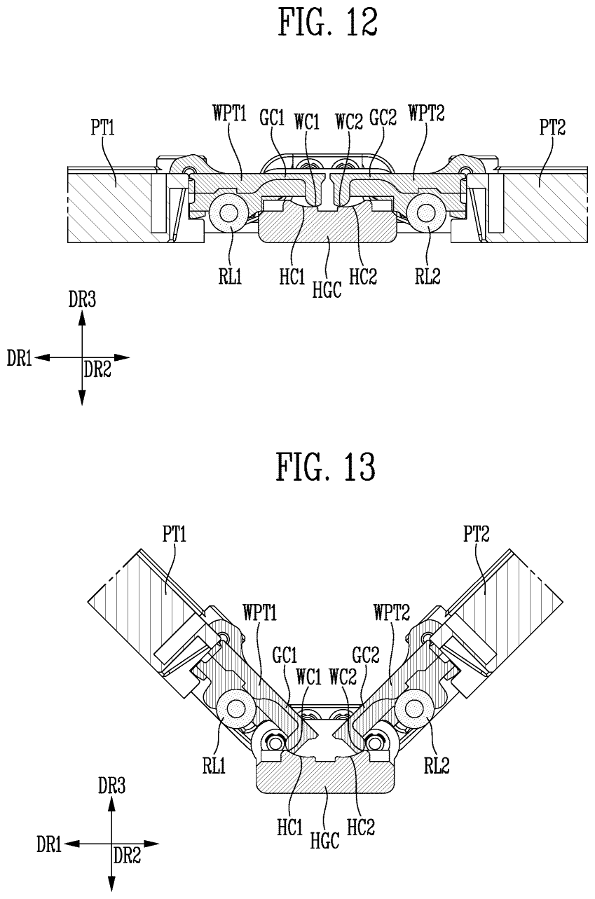

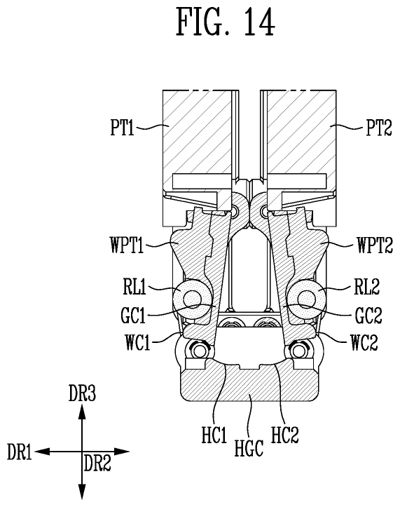

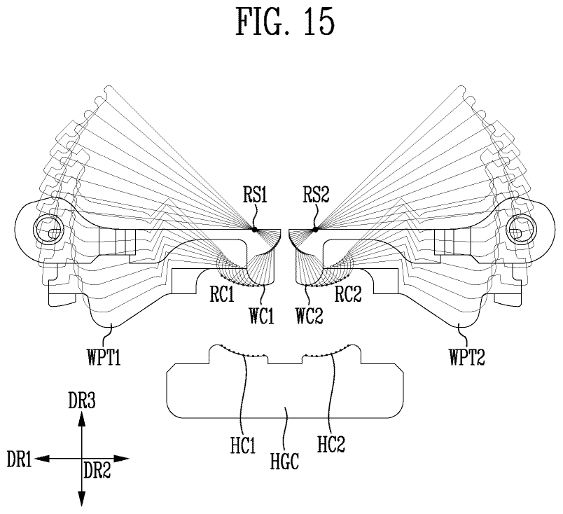

FIG. 6 is a perspective view of a folding set according to an embodiment. FIG. 7 is a perspective view of the folding set of FIG. 6 in a semi-folded state according to an embodiment. FIG. 8 is a perspective view of the folding set of FIG. 6 in a folded state according to one embodiment. FIG. 9 is a cross-sectional view of the folding set of FIG. 6 taken along line A-A′. FIG. 10 is a cross-sectional view of the folding set of FIG. 9 in a semi-folded state. FIG. 11 is a cross-sectional view of the folding set of FIG. 9 in a folded state. FIG. 12 is an enlarged cross-sectional view of wing plates and a hinge cover of the folding set of FIG. 9. FIG. 13 is an enlarged cross-sectional view of the wing plates and the hinge cover of the folding set of FIG. 12 in a semi-folded state. FIG. 14 is an enlarged cross-sectional view of the wing plates and the hinge cover of the folding set of FIG. 12 in a folded state. FIGS. 12 to 14 show the wing plates WPT1 and WPT2 and the hinge cover HGC as well as adjacent components together. FIG. 15 is an exemplary diagram illustrating wing plates and a hinge cover according to an embodiment.

A first period, in which the folding set FST is folded from the unfolded state of the folding set FST of FIG. 6 to the folding set FST of FIG. 7, may be defined as a first folding period, and a period, in which the folding set FST is folded from the folding sets FST of FIG. 7 to the folding set FST of FIG. 8, may be defined as a second folding period. For example, the first folding period may be a period in which an upper surface of the first plate PT1 and an upper surface of a second plate PT2 rotate at a first angle, for example, 90 degrees or more and 180 degrees or less, to place the folding set FST in a semi-folded state. The second folding period may be a period in which an upper surface of the first plate PT1 and an upper surface of a second plate PT2 rotate at a second angle, for example, an angle smaller than 90 degrees. The first folding period may be subsequent to an unfolding state (or an unfolded state), the second folding period may be subsequent to the first folding period, and the folding state (or a folded state) may be subsequent to the second folding period.

Referring to FIGS. 6 to 15, the folding set FST may include hinges HG disposed or located below the first and second wing plates WPT1 and WPT2 and a hinge cover HGC disposed or located below the hinges HG.

The hinges HG may be positioned between the first plate PT1 and the second plate PT2. The hinges HG may be disposed or located below the wing plates WPT1 and WPT2. The hinges HG may overlap the first and second wing plates WPT1 and WPT2. The hinges HG may overlap the folding area FA in a plan view.

The hinge HG may include levers LV, rollers RL1 and RL2, links LK1 and LK2, and/or coupling pins.

The levers LV may rotate with respect to rotation axes RS1 and RS2. The levers LV may rotate such that the display device DD (or the electronic device ED) may be folded. The levers LV may include a first lever LV1 and a second lever LV2 spaced apart from each other. The first lever LV1 may rotate with respect to a first rotation axis RS1, and the second lever LV2 may rotate with respect to a second rotation axis RS2.

The rollers RL1 and RL2 may be connected to the levers LV. The rollers RL1 and RL2 may be connected to the levers LV by the links LK1 and LK2. The links LK1 and LK2 may rotate with the levers LV1 and LV2. The first roller RL1 may be connected to the first lever LV1 by a first link LK1, and the second roller RL2 may be connected to the second lever LV2 by a second link LK2. In an embodiment, the rollers RL1 and RL2 may control rotation of the wing plates WPT1 and WPT2. The first wing plate WPT1 may rotate along the first lever LV1, and the second wing plate WPT2 may rotate along the second lever LV2. The first roller RL1 and the second roller RL2 may be spaced apart from each other. The first roller RL1 may be disposed or located on one (a first) side of the hinge cover HGC, and the second roller RL2 may be disposed or located on another (a second) side of the hinge cover HGC.

The levers LV may be coupled with the plates PT1 and PT2. The levers LV may be coupled with the plates PT1 and PT2 by the coupling pins (not shown). The first lever LV1 may be coupled with the first plate PT1, and the first plate PT1 may rotate along the first lever RV1. The second lever LV2 may be coupled with the second plate PT2, and the second plate PT2 may rotate along the second lever LV2.

The wing plates WPT1 and WPT2 may be coupled with the plates PT1 and PT2. The first wing plate WPT1 may be connected to the hinges HG and/or the first plate PT1. The second wing plate WPT2 may be connected with the hinges HG and/or the second plate PT2.

The first and second plates PT1 and PT2 and the first and second wing plates WPT1 and WPT2 may rotate about the first and second rotation axes RS1 and RS2. The first and second plates PT1 and PT2 and the first and second wing plates WPT1 and WPT2 may rotate such that the display device DD may be folded.

The hinge cover HGC may extend along the second direction DR2. The hinge cover HGC may be disposed or located below the hinges HG to at least partially cover the hinges HG. A lower surface of the hinge cover HGC may have a curved surface convex downward, and an upper surface of the hinge cover HGC may have a curved surface concave downward. The upper surface of the hinge cover HGC may include a curved surface that coincides or aligns with a rotational trajectory of a curved portion of the first and second wing plates WPT1 and WPT2. Reference is made to FIGS. 12 to 15 for a detailed description thereof.

Referring to FIGS. 12 to 15, the first wing plate WPT1 may include a first curved portion WC1 (or a first region). The second wing plate WPT2 may include a second curved portion WC2 (or a first region).

A lower surface of the first wing plate WPT1 may include the first curved portion WC1. An upper surface of the first wing plate WPT1 may be flat. The first curved portion WC1 may have a shape protruding in a direction opposite to the third direction DR3. In some embodiments, the first curved portion may protrude away from the flat upper surface of the first wing plate WPT1. The first curved portion WC1 may be located on one side (or an edge) of the first wing plate WPT1.

A lower surface of the second wing plate WPT2 may include the second curved portion WC2. An upper surface of the second wing plate WPT2 may be flat. The second curved portion WC2 may have a shape protruding in a direction opposite to the third direction DR3. In some embodiments, the second curved portion may protrude away from the flat upper surface of the second wing plate WPT2. The second curved portion WC2 may be located on one side (or an edge) of the second wing plate WPT2. The second curved portion WC2 may be spaced apart from the first curved portion WC1 in the first direction DR1. The second curved portion WC2 may face the first curved portion WC1 in the first direction DR1.

The upper surface of the hinge cover HGC may include a first curved surface HC1 and a second curved surface HC2. Referring to FIG. 15, the first curved surface HC1 may coincide or align with, or match, a rotation trajectory RC1 of the first curved portion WC1 in the first folding period in a cross-sectional view. For example, the first wing plate WPT1 may rotate about the first rotation axis RS1, and the first curved surface HC1 may have substantially the same shape as the rotation trajectory RC1 of the first curved portion WC1 in the first folding period in the cross-sectional view. In some embodiments, the first curved portion WC1 may be supported by the first curved surface HC1 while the first wing plate WPT1 rotates in the first folding period. For example, the first curved portion WC1 may be in contact with the first curved surface HC1 in the first folding period.

The second curved surface HC2 may coincide or align with, or match, a rotation trajectory RC2 of the second curved portion WC2 in the first folding period in a cross-sectional view. For example, the second wing plate WPT2 may rotate about the second rotation axis RS2, and the second curved surface HC2 may have substantially the same shape as the rotation trajectory RC2 of the second curved portion WC2 in the first folding period in a cross-sectional view. In some embodiments, the second curved portion WC2 may be supported by the second curved surface HC2 while the second wing plate WPT2 rotates in the first folding period. For example, the second curved portion WC2 may be in contact with the second curved surface HC2 in the first folding period.

As described above, in an embodiment where the wing plates WPT1 and WPT2 are supported by the hinge cover HGC in the first folding period, tilt of the wing plates WPT1 and WPT2 may be reduced or prevented from occurring while the wing plates WPT1 and WPT2 rotate. In some embodiments, a reduction or prevention of the tilt may help prevent or reduce a phenomenon of image distortion in the first folding period. In an embodiment, the upper surface of the first wing plate WPT1 and the upper surface of the first plate PT1 may be parallel to each other in the first folding period. The upper surface of the second wing plate WPT2 and the upper surface of second plate PT2 may be parallel to each other in the first folding period.

In the second folding period, the first curved portion WC1 may be spaced apart from (or outside of) the first curved surface HC1. In the second folding period, the first curved portion WC1 may not be in contact with the first curved surface HC1. In the second folding period, the second curved portion WC2 may be spaced apart from (or outside of) the second curved surface HC2. The second curved portion WC2 may not be in contact with the second curved surface HC2 in the second folding period.

In the second folding period, the first wing plate WPT1 may be controlled by the first roller RL1, and the second wing plate WPT2 may be controlled by the second roller RL2. For example, in the second folding period, the first wing plate WPT1 may be in contact with the first roller RL1, and the second wing plate WPT2 may be in contact to the second roller RL2.

The first wing plate WPT1 may include a first groove portion GC1 (or a second area). The second wing plate WPT2 may include a second groove portion GC2 (or a second area).

The lower surface of the first wing plate WPT1 may include the first groove portion GC1. The upper surface of the first wing plate WPT1 may be flat. The first groove portion GC1 may have a shape recessed in the third direction DR3. A thickness of the first groove portion GC1 in the third direction DR3 may be smaller than a thickness of the first curved portion WC1 in the third direction DR3.

The lower surface of the second wing plate WPT2 may include the second groove portion GC2. The upper surface of the second wing plate WPT2 may be flat. The second groove portion GC2 may have a shape recessed in the third direction DR3. A thickness of the second groove portion GC2 in the third direction DR3 may be smaller than a thickness of the second curved portion WC2 in the third direction DR3.

In the second folding period, the first groove portion GC1 may be in contact with the first roller RL1, and the second groove portion GC2 may be in contact with the second roller RL2. In some embodiments, a tilt may occur while the wing plates WPT1 and WPT2 rotate in the second folding period. For example, in the second folding period, the first wing plate WPT1 and the first plate PT1 may not be parallel. For example, an angle formed between the upper surface of the first wing plate WPT1 and the upper surface of the first plate PT1 in the second folding period may be greater than an angle formed between the upper surface of the second wing plate WPT1 and the upper surface of the first plate PT1 in the first folding period. In the second folding period, the upper surface of the second wing plate WPT2 and the upper surface of second plate PT2 may not be parallel (or non-parallel or converging) to each other. For example, an angle formed between the upper surface of the second wing plate WPT2 and the upper surface of the second plate PT2 in the second folding period may be greater than an angle formed between the upper surface of the second wing plate WPT2 and the upper surface of the second plate PT2 in the first folding period. For example, as shown in FIG. 14, in the folded state, the upper surface of the first wing plate WPT1 and the upper surface of the second wing plate WPT2 may not be parallel to each other. As such, as the tilt of the wing plates WPT1 and WPT2 occurs in the second folding period, the upper surface of the first plate PT1 and the upper surface of the second plate PT2 may be folded so as to be parallel in the folded state. For example, in the folded state, the angle between the upper surface of the first wing plate WPT1 and the upper surface of the second wing plate WPT2 may be greater than 0 degrees, and the angle between the upper surface of the first plate PT1 and the upper surface of the second plate PT2 may be about 0 degrees. In this regard, a gap between the first and second folding areas NFA1 and NFA2 facing each other in the folding state may be reduced or minimized, and a thickness of the electronic device ED may be reduced.

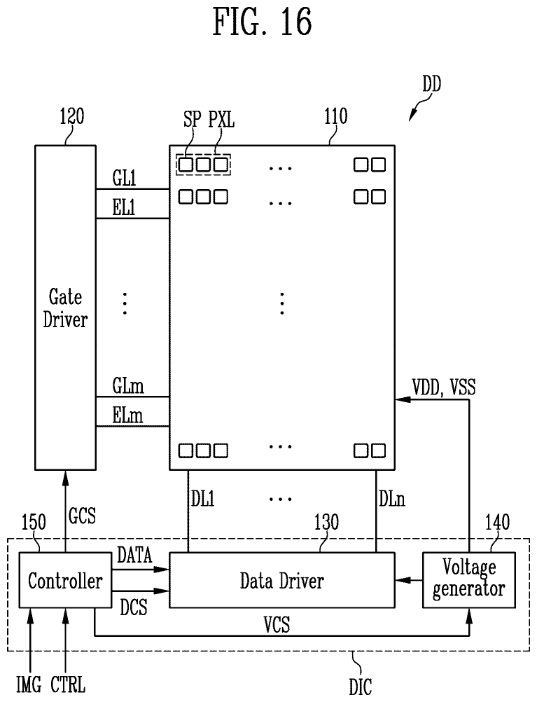

FIG. 16 is a block diagram of a display device according to an embodiment.

Referring to FIG. 16, a display device DD may include a display panel 110, a gate driver 120, a data driver 130, a voltage generator 140, and a controller 150.

The display panel 110 may include sub-pixels SP. The sub-pixels SP may be connected to the gate driver 120 through first to m-th gate lines GL1 to GLm. The sub-pixels SP may be connected to the data driver 130 through first to n-th data lines DL1 to DLn.

One or more (e.g., each) of the sub-pixels SP may include at least one light emitting element configured to generate light. In some embodiments, one or more (e.g., each) of the sub-pixels SP may generate light of a specific color, such as red, green, blue, cyan, magenta, yellow, or the like. Two or more sub-pixels of the sub-pixels SP may constitute one pixel PXL. For example, as shown in FIG. 16, the three sub-pixels SP may constitute one pixel PXL.

The gate driver 120 may be connected to the sub-pixels SP arranged in a row direction through the first to m-th gate lines GL1 to GLm. The gate driver 120 may output gate signals to the first to m-th gate lines GL1 to GLm in response to a gate control signal GCS from the controller 150. In an embodiment, the gate control signal GCS may include a start signal indicating a start of each frame, a horizontal synchronization signal for outputting gate signals in synchronization with a timing at which data signals are applied, and/or the like.

In an embodiment, first to m-th light emission control lines EL1 to ELm connected to the sub-pixels SP in the row direction may be further provided. In this case, the gate driver 120 may include a light emission control driver configured to control the first to m-th light emission control lines EL1 to ELm, and the light emission control driver may operate according to control of the controller 150.

The gate driver 120 may be located on one side of the display panel 110. However, embodiments are not limited thereto. For example, the gate driver 120 may be divided into two or more drivers that are physically and/or logically divided, and such drivers may be located on one side of the display panel 110 and another side of the display panel 110 opposite to the one side. As such, the gate driver 120 may be located around the display panel 110 in various forms according to embodiments.

The data driver 130 may be connected to the sub-pixels SP arranged in a column direction through the first to n-th data lines DL1 to DLn. The data driver 130 may receive image data DATA and a data control signal DCS from the controller 150. The data driver 130 may operate in response to the data control signal DCS. In an embodiment, the data control signal DCS may include a source start pulse, a source shift clock, a source output enable signal, and/or the like.

The data driver 130 may use voltages from the voltage generator 140 to apply data signals having grayscale voltages corresponding to the image data DATA to the first to n-th data lines DL1 to DLn. When a gate signal is applied to one or more (e.g., each) of the first to m-th gate lines GL1 to GLm, data signals corresponding to the image data DATA may be applied to the data lines DL1 to DLm. In some embodiments, the corresponding sub-pixels SP may generate light corresponding to the data signals. In some embodiments, an image may be displayed on the display panel 110.

In an embodiment, the gate driver 120 and the data driver 130 may include complementary metal-oxide semiconductor (CMOS) circuit elements.

The voltage generator 140 may operate in response to a voltage control signal VCS from the controller 150. The voltage generator 140 may be configured to generate voltages and provide the generated voltages to components of the display device 100. For example, the voltage generator 140 may be configured to generate voltages by receiving an input voltage from outside the display device 100, adjusting the received voltage, and regulating the adjusted voltage.

The voltage generator 140 may generate a first power voltage VDD and a second power voltage VSS, and the generated first and second power voltages VDD and VSS may be provided to the sub-pixels SP. The first power voltage VDD may have a relatively high voltage level, and the second power voltage VSS may have a lower voltage level than the first power source voltage VDD. In one or more embodiments, the first power voltage VDD or the second power voltage VSS may be provided by a device external to the display device 100.

In addition, the voltage generator 140 may generate various voltages. For example, the voltage generator 140 may generate an initialization voltage applied to the sub-pixels SP. For example, in a sensing operation for sensing electrical characteristics of transistors and/or light-emitting elements of the sub-pixels SP, a specific reference voltage may be applied to the first to n-th data lines DL1 to DLn, and the voltage generator 140 may generate such the reference voltage.

The controller 150 may control various operations of the display device 100. The controller 150 may receive input image data IMG and a control signal CTRL for controlling a display thereof from the outside. The controller 150 may provide the gate control signal GCS, the data control signal DCS, and the voltage control signal VCS in response to the control signal CTRL.

The controller 150 may convert the input image data IMG to be suitable for the display device 100 or the display panel 110 and output the image data DATA. In an embodiment, the controller 150 may output the image data DATA by arranging the input image data IMG to fit the sub-pixels SP in row units.

Two or more components among the data driver 130, the voltage generator 140, and the controller 150 may be mounted in one integrated circuit (IC). The data driver 130, the voltage generator 140, and the controller 150 may be included in a driver integrated circuit DIC. In this case, the data driver 130, the voltage generator 140, and the controller 150 may be functionally distinct components within one driver integrated circuit DIC. In one or more embodiments, at least one among the data driver 130, the voltage generator 140, and the controller 150 may be provided as a component separate from the driver integrated circuit DIC.

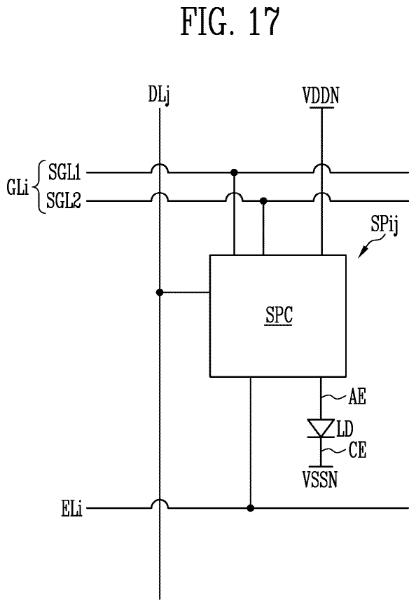

FIG. 17 is a block diagram illustrating an embodiment of one of sub-pixels of the display device of FIG. 16. FIG. 17 shows, as an example, a sub-pixel SPij arranged in an i-th row (i is an integer greater than or equal to 1 and less than or equal to m) and a j-th column (j is an integer greater than 1 and less than that n) from among the sub-pixels SP of FIG. 16.

Referring to FIG. 17, the sub-pixel SPij may include a sub-pixel circuit SPC and a light-emitting element LD.

The light-emitting element LD may be connected between a first power voltage node VDDN and a second power voltage node VSSN. The first power voltage node VDDN may be a node that transmits the first power voltage VDD of FIG. 16, and the second power voltage node VSSN may be a node that transmit the second power voltage VSS of FIG. 16.

An anode electrode AE of the light-emitting element LD may be connected to the first power voltage node VDDN through the sub-pixel circuit SPC, and a cathode electrode CE of the light-emitting element LD may be connected to the second power voltage node VSSN. For example, the anode electrode AE of the light-emitting element LD may be connected to the first power voltage node VDDN through one or more transistors included in the sub-pixel circuit SPC.

The sub-pixel circuit SPC may be connected to an i-th gate line GLi from among the first to m-th gate lines GL1 to GLm of FIG. 16, an i-th light emission control line ELi among the first to n-th light emitting control lines EL1 to ELm of FIG. 16, and a j-th data line DLj from among the first to n-th data lines DL1 to DLn of FIG. 16. The sub-pixel circuit SPC may be configured to control the light-emitting element LD according to signals received through these signal lines.

The sub-pixel circuit SPC may operate in response to a gate signal received through the i-th gate line GLi. The i-th gate line GLi may include one or more sub-gate lines. In an embodiment, the i-th gate line GLi may include first and second sub-gate lines SGL1 and SGL2. The sub-pixel circuit SPC may operate in response to gate signals received through the first and second sub-gate lines SGL1 and SGL2. As such, in an embodiment where the i-th gate line GLi includes two or more sub-gate lines, the sub-pixel circuit SPC may operate in response to gate signals received through the corresponding sub-gate lines.

The sub-pixel circuit SPC may operate in response to a light emission control signal received through the i-th light emission control line ELi. In an embodiment, the i-th light emission control line ELi may include one or more sub-light emission control lines. In an embodiment where the i-th light emission control line ELi includes two or more sub-light light emission control lines, the sub-pixel circuit SPC may operate in response to light emission control signals received through the corresponding sub-light emission control line.

The sub-pixel circuit SPC may receive a data signal through the j-th data line DLj. The sub-pixel circuit SPC may store a voltage corresponding to the data signal in response to at least one of the gate signals received through the first and second sub-gate lines SGL1 and SGL2. The sub-pixel circuit SPC may adjust a current flowing from the first power voltage node VDDN to the second power voltage node VSSN through the light-emitting element LD according to the stored voltage in response to the light-emitting control signal received through the i-th light-emitting control line ELi. In some embodiments, the light-emitting element LD may generate light having a luminance corresponding to the data signal.

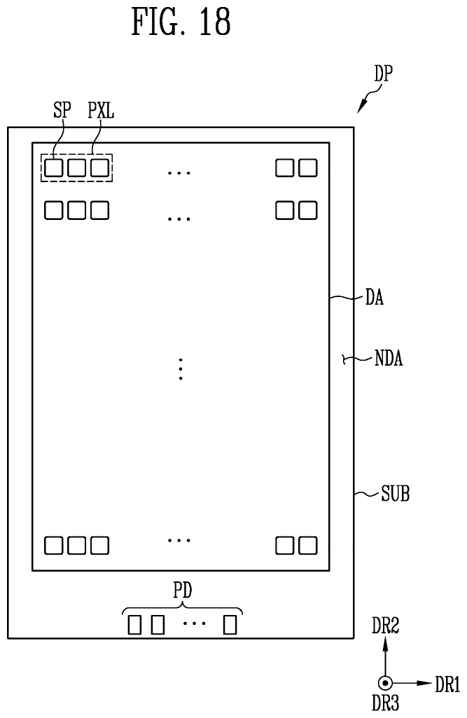

FIG. 18 is a plan view of a display panel of the display device of FIG. 16 according to one embodiment.

Referring to FIG. 18, an embodiment DP of the display panel 110 of FIG. 16 may include a display area DA and a non-display area NDA. The display panel DP may display an image through the display area DA. The non-display area NDA may be located around the display area DA.

The display panel DP may include a substrate SUB, sub-pixels SP, and pads PD.

The sub-pixels SP may be located in the display area DA on the substrate SUB. The sub-pixels SP may be arranged in a matrix form along a first direction DR1 and a second direction DR2 intersecting the first direction DR1. However, embodiments are not limited thereto. For example, the sub-pixels SP may be arranged in a zigzag shape along the first direction DR1 and the second direction DR2. For example, the sub-pixels SP may be arranged in a PENTILE® form. The PENTILE® pixel arrangement structure may be referred to as an RGBG matrix structure (e.g., a PENTILE® matrix structure or an RGBG structure (e.g., a PENTILE® structure)). PENTILE® is a registered trademark of Samsung Display Co., Ltd., Republic of Korea. The first direction DR1 may be a row direction, and the second direction DR2 may be a column direction. Two or more sub-pixels of the sub-pixels SP may constitute one pixel PXL.

A component for controlling the sub-pixels SP may be located in the non-display area NDA on the substrate SUB. For example, wirings connected to the sub-pixels SP such as the first to m-th gate lines GL1 to GLm and the first to n-th data lines DL1 to DLn of FIG. 16 may be located in the non-display area NDA.

At least one among the gate driver 120, the data driver 130, the voltage generator 140, and the controller 150 of FIG. 16 may be integrated in the non-display area NDA of the display panel DP. In an embodiment, the gate driver 120 of FIG. 16 may be mounted on the display panel DP and disposed or located in the non-display area NDA. In one or more embodiments, the gate driver 120 may be implemented as an integrated circuit separate from the display panel DP.

The pads PD may be located in the non-display area NDA on the substrate SUB. The pads PD may be electrically connected to the sub-pixels SP through wirings. For example, the pads PD may be connected to the sub-pixels SP through the first to n-th data lines DL1 to DLn.

The pads PD may interface the display panel DP to other components of the display device 100. In an embodiment, voltages and signals necessary for operation of components included in the display panel DP may be provided from the driver integrated circuit DIC of FIG. 16 through the pads PD. For example, the first to n-th data lines DL1 to DLn may be connected to the driver integrated circuit DIC through the pads PD. For example, the first and second power voltages VDD and VSS may be received from the driver integrated circuit DIC via the pads PD. For example, in an embodiment where the gate driver 120 is mounted on the display panel DP, the gate control signal GCS may be transmitted from the driver integrated circuit DIC to the gate driver 120 through the pads PD.

In an embodiment, a circuit board may be electrically connected to the pads PD using a conductive adhesive member such as an anisotropic conductive film. In this case, the circuit board may be a flexible circuit board (FPCB) or a flexible film having a flexible material. The driver integrated circuit DIC may be mounted on a circuit board and electrically connected to the pads PD.

In an embodiment, the display area DA may have various shapes. The display area DA may have a shape of a closed loop comprising straight and/or curved sides. For example, the display area DA may have shapes such as a polygon, a circle, a semicircle, and an ellipse.

In an embodiment, the display panel DP may have a flat display surface. In one or more embodiments, the display panel DP may have an at least partially rounded display surface. In an embodiment, the display panel DP may be bendable, foldable, or rollable. In such cases, the display panel DP and/or the substrate SUB may include materials having a flexible property.

The display device DD according to an embodiment may be applied to various electronic devices ED. The electronic device ED according to an embodiment includes the above-described display device DD, and may further include a module or device having an additional function other than the display device DD.

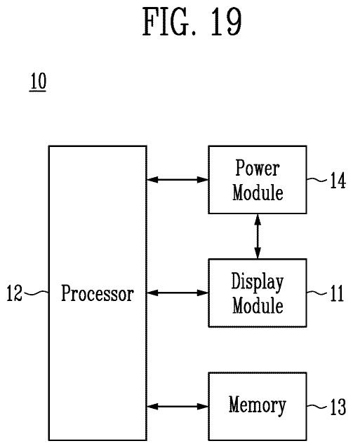

FIG. 19 is a block diagram of an electronic device according to an embodiment. Referring to FIG. 19, an embodiment 10 of the electronic device ED of FIG. 1 may include a display module 11, a processor 12, a memory 13, and a power module 14.

The processor 12 may include a central processing unit (CPU), an application processor (AP), a graphics processing unit (GPU), a communication processor (CP), an image signal processor (ISP), and/or a controller.

The memory 13 may store data information necessary for the operation of the processor 12 or the display module 11. When the processor 12 executes an application stored in the memory 13, an image data signal and/or an input control signal are transmitted to the display module 11, and the display module 11 may process the received signal and output image information through a display screen, that is, a pixel.

The power module 14 may include a power supply module such as a power adapter or a battery device, and a power conversion module that converts power supplied by the power supply module to generate power required for operation of the electronic device 10.

At least one of the above-described components of the electronic device 10 may be included in the display device according to the above-described embodiments. In addition, some of the individual modules functionally included in one module may be included in the display device, and other parts may be provided separately from the display device. For example, the display device may include the display module 11, and the processor 12, the memory 13, and/or the power module 14 may be provided in the form of other devices in the electronic device 10 other than the display device.

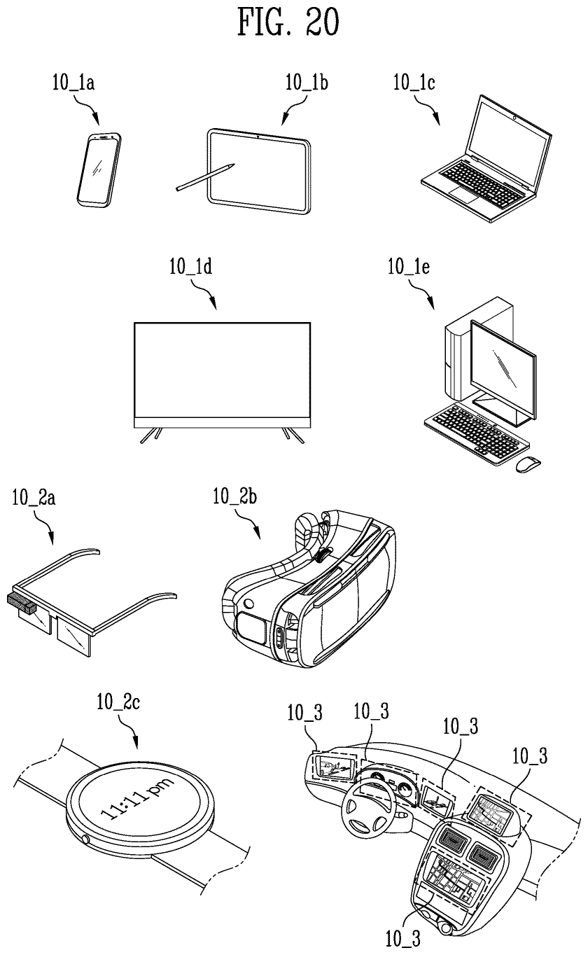

FIG. 20 is a schematic diagram of an electronic device according to various embodiments.

Referring to FIG. 20, various electronic devices to which a display device is applied according to embodiments may include not only an electronic device for displaying an image such as a smartphone 10_1a, a tablet PC 10_1b, a laptop 10_1c, a television (TV) 10_1d, and/or a desk monitor 10_1e, but also a wearable electronic device including a display module such as smart glasses 10_2a, a head mounted display 10_2b, and/or a smart watch 10_2c, an electronic device for a vehicle 10_3 including a display module, such as a Center Information Display (CID) disposed or located on an instrument panel, a center fascia, and/or a dashboard of a vehicle, a room mirror display, and/or the like.

Although certain embodiments have been described herein, other embodiments and variations may be derived from the above description. Thus, the spirit of the present disclosure is not limited to these embodiments, but extends to the claims set forth below, various obvious modifications, and equivalents.

What is claimed is:

1. An electronic device comprising:
a display device;
a first plate and a second plate under the display device;
a hinge between the first plate and the second plate;
a hinge cover covering the hinge below the hinge;
a first wing plate connected with the hinge and the first plate; and
a second wing plate connected with the hinge and the second plate,
wherein, in a first folding period in which the first plate and the second plate are configured to rotate at a first angle:
a first curved surface of the hinge cover coincides with a first rotation trajectory of a first curved portion of the first wing plate in a cross-sectional view; and
a second curved surface of the hinge cover coincides with a second rotation trajectory of a second curved portion of the second wing plate in the cross-sectional view.

2. The electronic device of claim 1, wherein the first curved surface of the hinge cover is in contact with the first curved portion of the first wing plate in the first folding period.

3. The electronic device of claim 1, wherein the first wing plate and the first plate are parallel in the first folding period.

4. The electronic device of claim 1, wherein the first angle is greater than or equal to 90 degrees and less than or equal to 180 degrees.

5. The electronic device of claim 1, wherein, in a second folding period in which the first plate and the second plate are configured to rotate at a second angle, the first curved portion of the first wing plate is spaced apart from the first curved surface of the hinge cover.

6. The electronic device of claim 5, wherein the hinge includes a first roller on a first side of the hinge cover and a second roller on a second side of the hinge cover.

7. The electronic device of claim 6, wherein the first roller is in contact with the first wing plate in the second folding period.

8. The electronic device of claim 7, wherein the first wing plate includes a groove portion in contact with the first roller in the second folding period, and a thickness of the groove portion is smaller than a thickness of the curved portion.

9. The electronic device of claim 5, wherein the first wing plate and the first plate are non-parallel in the second folding period.

10. The electronic device of claim 5, wherein an angle formed between the first wing plate and the first plate in the second folding period is greater than an angle formed between the first wing plate and the first plate in the first folding period.

11. The electronic device of claim 5, wherein the second angle is less than 90 degrees.

12. The electronic device of claim 1, further comprising:
a first lever configured to rotate with respect to a first rotation axis and a second lever configured to rotate with respect to a second rotation axis,
wherein the first wing plate is configured to rotate along the first lever and the second wing plate is configured to rotate along the second lever.

13. An electronic device comprising:
a display device;
a first plate and a second plate under the display device;
a hinge disposed between the first plate and the second plate and including a first roller and a second roller spaced apart from each other;
a hinge cover below the hinge and covering the hinge;
a first wing plate connected with the hinge and the first plate; and
a second wing plate connected with the hinge and the second plate,
wherein, in a first folding period in which the first plate and the second plate are configured to rotate at a first angle, a first area of the first wing plate is in contact with a first curved surface of the hinge cover, and a second area of the second wing plate is in contact with a second curved surface of the hinge cover, and
wherein, in a second folding period in which the first plate and the second plate are configured to rotate at a second angle, the first area of the first wing plate is in contact with the first roller, and the second area of the second wing plate is in contact with the second roller.

14. The electronic device of claim 13, wherein the first area of the first wing plate is spaced apart from the first curved surface of the hinge cover in the second folding period.

15. The electronic device of claim 13, wherein an angle formed between the first wing plate and the first plate in the second folding period is greater than an angle formed between the first wing plate and the first plate in the first folding period.

16. The electronic device of claim 13, wherein the first wing plate and the first plate are parallel in the first folding period.

17. The electronic device of claim 13, wherein, in the second folding period, an angle between the first plate and the second plate is greater than an angle between the first wing plate and the second wing plate.

18. The electronic device of claim 13, wherein the first angle is greater than or equal to 90 degrees and less than or equal to 180 degrees.

19. The electronic device of claim 13, wherein the second angle is less than 90 degrees.

20. The electronic device of claim 13, wherein a thickness of the first area of the first wing plate is greater than a thickness of the second area of the first wing plate.
